(19) United States
(12) Patent Application Publication
(10) Pub. No.: US 2019/0289157 A1
(43) Pub. Date: Sep. 19, 2019

(54) INFORMATION PROCESSING SYSTEM, INFORMATION PROCESSING METHOD AND NON-TRANSITORY COMPUTER-READABLE STORAGE MEDIUM

(71) Applicants: Dongzhe ZHANG, Kanagawa (JP); Ryohsuke Yoshihashi, Kanagawa (JP)

(72) Inventors: Dongzhe ZHANG, Kanagawa (JP); Ryohsuke Yoshihashi, Kanagawa (JP)

(21) Appl. No.: 16/297,245

(22) Filed: Mar. 8, 2019

(30) Foreign Application Priority Data
Mar. 16, 2018 (JP) 2018-049405

(51) Int. Cl. H04N 1/00

(52) U.S. Cl. CPC H04N 1/00949; H04N 2201/0094; H04N 1/00464; H04N 1/00228

(57) ABSTRACT

An information processing system includes a device having one or more functions and a service providing system configured to execute an application in which an execution order of programs is defined to execute a process flow using at least one of the one or more functions. The service providing system includes circuitry configured to: acquire device information regarding the device from the device based on setting information input by a user via an operation device provided with the device; and execute the process flow for processing the acquired device information.

### CROSS-REFERENCE TO RELATED APPLICATION

This patent application is based on and claims priority pursuant to 35 U.S.C. § 119(a) to Japanese Patent Application No. 2018-049405, filed on Mar. 16, 2018, in the Japan Patent Office, the entire disclosure of which is hereby incorporated by reference herein.

### BACKGROUND

### Technical Field

The present disclosure relates to an information processing system, an information processing method, and a non-transitory computer-readable storage medium.

### Description of Related Art

### Description of the Related Art

In recent years, services are known that provide a function including a combination of a plurality of functions (for example, scanning, printing, e-mail delivery, etc.). For example, a service is known that performs a predetermined process on an electronic file (image file) generated by scanning and then delivering an electronic mail to which the electronic file on which the predetermined process has been performed is attached. Such service is achieved by executing one or more processes in series, each process implementing each function.

For example, in order to support a development of an application for executing a series of processes (processing flow) using functions of a device such as a multifunction peripheral (MFP), a system is known in which a service providing system generates an application for executing a process flow desired by a user on the basis of information that the user has input by using an information processing apparatus such as a personal computer (PC) terminal, and registers the generated application in a device, and thus the user can use a desired application when operating the device. The system as described provides, for example, a service that performs optical character recognition (OCR) processing on image data of a document scanned by the device and then transmitting the data translated into a predetermined language to a predetermined information processing apparatus, and a service for attaching a QR code (registered trademark) to an electronic file generated by scanning and then printing the electronic file to which the QR code is attached

### SUMMARY

An information processing system includes a device having one or more functions and a service providing system configured to execute an application in which an execution order of programs is defined to execute a process flow using at least one of the one or more functions. The service providing system includes circuitry configured to: acquire device information regarding the device from the device based on setting information input by a user via an operation device provided with the device; and execute the process flow for processing the acquired device information.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a configuration of an information processing system, according to an embodiment of the present disclosure;

FIG. 2 is a block diagram illustrating an example of a hardware configuration of a service providing system and a personal computer (PC) terminal, according to an embodiment of the present disclosure;

FIG. 3 is a block diagram illustrating an example of a hardware configuration of a device, according to an embodiment of the present disclosure;

FIG. 4 is a block diagram illustrating an example of a functional configuration of the information processing system, according to an embodiment of the present disclosure;

FIG. 5 is a block diagram illustrating an example of a functional configuration of a logic processing unit, according to an embodiment of the present disclosure;

FIG. 6 is a diagram illustrating an example of a type conversion information table, according to an embodiment of the present disclosure;

FIG. 7 is a sequence diagram illustrating an example of an application registration process, according to an embodiment of the present disclosure;

FIG. 8 is a diagram illustrating an example of a portal top screen, according to an embodiment of the present disclosure;

FIG. 9 is a diagram illustrating an example of an application registration screen, according to an embodiment of the present disclosure;

FIG. 10 is a diagram illustrating an example of a flow registration screen, according to an embodiment of the present disclosure;

FIG. 11 is a diagram illustrating an example of device information, according to an embodiment of the present disclosure;

FIG. 12 is a sequence diagram illustrating an example of an overall process in a case where a device information transmission service is used, according to an embodiment of the present disclosure;

FIG. 13 is a diagram illustrating an example of a first application screen, according to an embodiment of the present disclosure; and

FIG. 14 is a diagram illustrating an example of a second application screen, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

In a system that executes a predetermined process flow using a function of devices such as an image forming apparatus such as an MFP, a PC (personal computer), a projector, an electronic whiteboard, a digital camera, to provide a service, a function of acquiring device information regarding the devices is desired for maintenance or the like of each device. However, in a conventional system, such function cannot be implemented.

According to an embodiment described below, in a system that executes a process flow using a function of a device, it is possible to easily provide a service that acquires and uses device information regarding the device.

An embodiment of an information processing system, an information processing method, and a non-transitory computer-readable storage medium will be described in detail below with reference to the accompanying drawings. The present disclosure is not limited by the following embodiment, and components in the following embodiment include those which can be easily conceived by a person skilled in the art, substantially the same one, and those in a so-called equivalent range. Various omissions, substitutions, changes, and combinations of the components can be made without departing from the gist of the following embodiment.

Hereinafter, an embodiment of the present disclosure will be described in detail with reference to the drawings.

### System Configuration

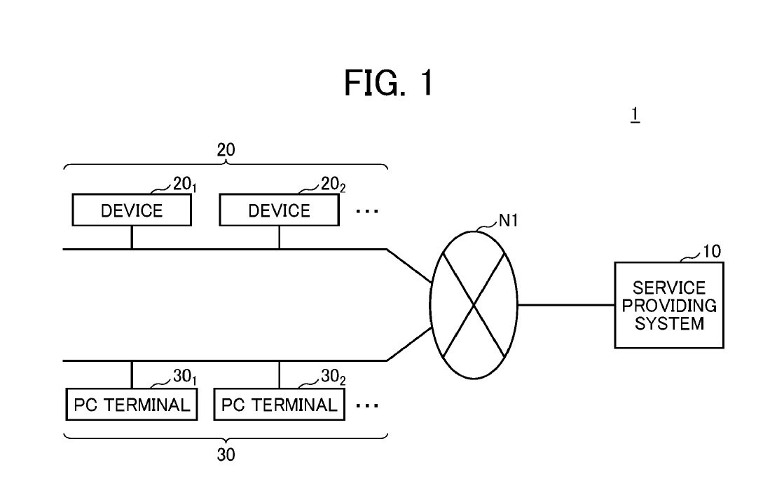

First, a system configuration of an information processing system 1 according to the present embodiment will be described with reference to FIG. 1. FIG. 1 is a diagram illustrating an example of a configuration of the information processing system 1 according to the present embodiment.

The information processing system 1 illustrated in FIG. 1 includes a service providing system 10, a device 201, a device 202 (collectively or individually referred to as “device 20”, unless they have to be distinguished), and a personal computer (PC) terminal 30₁, a PC terminal 30₂ (collectively or individually referred to as “PC terminal 30”, unless they have to be distinguished), which are communicably connected via a wide area network N1 such as the Internet.

The service providing system 10 is implemented by one or more information processing apparatuses. The service providing system provides via the network N1 various services implemented by a series of processes in which one or more processes among a plurality of processes that respectively implement functions are combined.

The function is a function relating to an electronic file such as a document file and an image file. Examples of the function include printing, scanning, facsimile transmission, data format conversion, e-mail transmission, data transmission other than e-mail transmission, optical character recognition (OCR) process, processing on the electronic file, compression/decompression, and storage in a repository.

A specific example of a service provided by the service providing system 10 according to the present embodiment will be described later. Hereinafter, a series of processes is also referred to as a “process flow”.

The device 20 is an electronic device of various types used by a user. For example, the device 20 is an image forming apparatus such as an MFP, a personal computer (PC), a projector, an electronic whiteboard, a digital camera, or the like. The user can use various functions of the device 20 to use various services provided by the service providing system 10.

Hereinafter, the device 20 is referred to as a “device 20₁” and a “device 20₂”, or the like, when distinction between the devices are needed.

The PC terminal 30 is, for example, a desktop PC, a laptop PC, a smartphone, a tablet terminal, or the like used by the user. The user can use the PC terminal 30 to use various services provided by the service providing system 10.

Hereinafter, the PC terminal 30 is referred to as a “PC terminal 30₁”, a “PC terminal 30₂”, or the like, when distinction between the PC terminals are needed.

In addition, a configuration of the information processing system 1 illustrated in FIG. 1 is merely an example, and other configurations may be used. For example, the information processing system 1 according to the present embodiment includes a device of various types that performs at least one of input and output of electronic data, and the device can use various services provided by the service providing system 10.

### Hardware Configuration

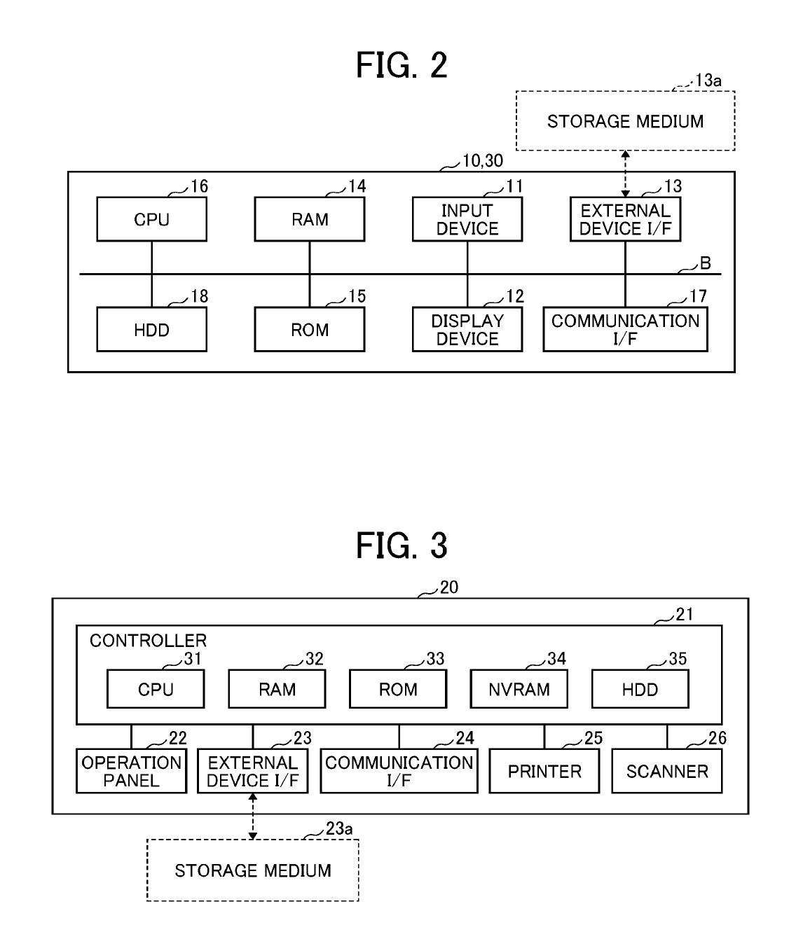

Next, a hardware configuration of the service providing system 10 and the PC terminal 30 included in the information processing system 1 according to the present embodiment will be described with reference to FIG. 2. FIG. 2 is a block diagram illustrating an example of a hardware configuration of the service providing system 10 and the PC terminal 30 according to the present embodiment. Since the service providing system 10 and the PC terminal 30 have a same hardware configuration, the hardware configuration of the service providing system 10 will mainly be described below.

The service providing system 10 illustrated in FIG. 2 includes an input device 11, a display device 12, an external device interface (I/F) 13, and a random access memory (RAM) 14. In addition, the service providing system 10 includes a read only memory (ROM) 15, a central processing unit (CPU) 16, a communication I/F 17, and a hard disk drive (HDD) 18. Each of these pieces of hardware is connected by a bus B.

The input device 11 includes a keyboard, a mouse, a touch panel, and the like, and is used by the user to input operation signals. The display device 12 includes a display and the like, and displays a result of a process by the service providing system 10. At least one of the input device 11 and the display device 12 may be connected to the service providing system 10 for use when needed.

The communication I/F 17 is an interface that connects the service providing system 10 to the network N1. With this, the service providing system 10 can communicate via the communication I/F 17.

The HDD 18 is a nonvolatile storage device that stores programs and data. The programs and data stored in the HDD 18 include an Operating System (OS) that is basic software for controlling entire operation of the service providing system 10, application software for providing various functions on the OS, and the like.

In another example, the service providing system 10 can use a drive device (for example, a solid state drive: SSD) that uses a flash memory as a storage medium as an alternative to the HDD 18. In addition, the HDD 18 manages the stored programs and data by a predetermined file system and/or a database (DB).

The external device I/F 13 is an interface with an external device. The external device is a storage medium 13a, or the like. The service providing system 10 can read and write data from and to the storage medium 13a via the external device I/F 13. The storage medium 13a is a flexible disk, a CD, a DVD, an SD memory card, a USB memory, or the like.

The ROM 15 is a nonvolatile semiconductor memory that is capable of holding programs and data even after a power is turned off. The ROM 15 stores programs and data such as Basic Input/Output System (BIOS), OS setting, network setting and the like executed at a time of starting the service providing system 10. The RAM 14 is a volatile semiconductor memory that temporarily holds programs and data.

The CPU 16 is a computing device that reads programs and data from a storage device such as the ROM 15 and the HDD 18 onto the RAM 14 and executes a process, thereby implementing a control and a function of entire operation of the service providing system 10.

The service providing system 10 and the PC terminal 30 according to the present embodiment have the hardware configuration illustrated in FIG. 2, and thus can carrying out various processes as described later.

Next, a hardware configuration in a case where the device 20 included in the information processing system 1 according to the present embodiment is an image forming apparatus will be described with reference to FIG. 3. FIG. 3 is a diagram illustrating a hardware configuration of an example of the device 20 according to the present embodiment.

The device 20 illustrated in FIG. 3 includes a controller 21, an operation panel 22 (operation device), an external device I/F 23, a communication I/F 24, a printer 25, and a scanner 26. In addition, the controller 21 includes a CPU 31, a RAM 32, a ROM 33, a non-volatile random-access memory (NVRAM) 34, and an HDD 35.

The ROM 33 is a nonvolatile semiconductor memory that stores various programs and data. The RAM 32 is a volatile semiconductor memory that temporarily holds programs and data. The NVRAM 34 stores setting information and the like, for example. In addition, the HDD 35 is a nonvolatile storage device that stores various programs and data.

The CPU 31 is a computing device that reads programs, data, setting information, or the like from the ROM 33, the NVRAM 34, the HDD 35, or the like onto the RAM 32 and executes a process, thereby implementing a control and a function of entire operation of the device 20.

The operation panel 22 includes an input unit that accepts an input from the user and a display unit that performs display. The external device I/F 23 is an interface with an external device. The external device is a storage medium 23a, or the like. The device 20 can read and write data to and from the storage medium 23a via the external device I/F 23. The storage medium 23a is, for example, a flexible disk, a CD, a DVD, an SD memory card, a USB memory, or the like.

The communication I/F 24 is an interface which connects the device 20 to a network. With this, the device 20 can communicate via the communication I/F 24. The printer 25 is a printing device that prints print data. The scanner 26 is a reading device that reads a document and generates an electronic file (image file).

The device 20 according to the present embodiment includes the hardware configuration illustrated in FIG. 3, and thus can carry out various processes as described later.

### Service Provided by Service Providing System

The service provided by the service providing system 10 according to the present embodiment will be described. Hereinafter, it is assumed that the device 20 is an image forming apparatus.

The service providing system 10 according to the present embodiment provides a “device information transmission service” that acquires device information regarding the device 20 and transmits the acquired device information to a predetermined information processing apparatus set as a transmission destination.

On the basis of setting information input by a user, the service providing system 10 generates a “device information transmission application” that executes a process flow for providing the device information transmission service, and registers the device information transmission application in the device 20. With this, the user can use the device information transmission application via a user interface (such as the operation panel 22) of the device 20. In the present embodiment, a case where the user inputs, via the PC terminal 30, the setting information for generating the device information transmission application will be described.

The service provided by the service providing system 10 is not limited to the “device information transmission service”. For example, in addition to the “device information transmission service”, the service providing system 10 can provide a “scan translation service” that performs an OCR process on an electronic file (image file) generated by scanning a document on the device 20, and then transmits by e-mail or the like data obtained by translating the file into a predetermined language, a “QR code printing service” that attaches a QR code to an electronic file generated by scanning and then prints the electronic file to which the QR code is attached, an “encrypted data transmission service” that encrypts an electronic file and transmits the electronic file by e-mail, and the like. In these cases, on the basis of the setting information input by the user, the service providing system 10 generates a “scan translation application” that executes a process flow for providing the scan translation service, a “QR code printing application” that executes a process flow for providing the QR code printing service, and an “encrypted data transmission application” that executes a process flow for providing an encrypted data transmission service, and registers these applications in the device 20.

### Functional Configuration

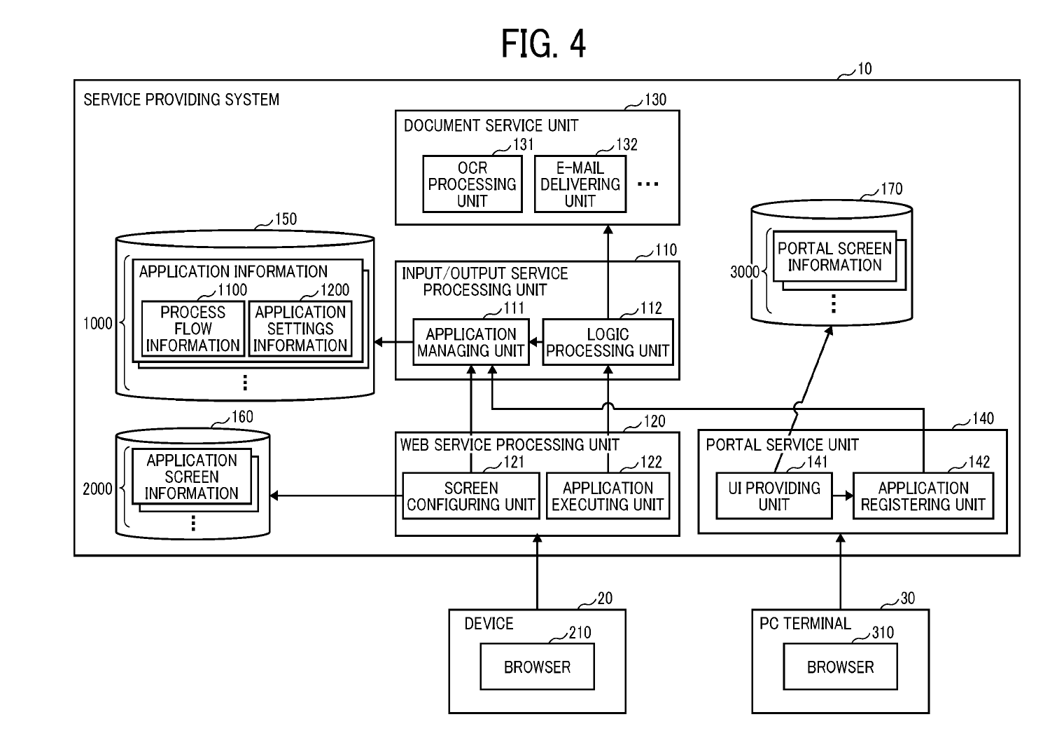

Next, a functional configuration of the information processing system 1 according to the present embodiment will be described with reference to FIG. 4. FIG. 4 is a block diagram illustrating an example of a functional configuration of the information processing system 1 according to the present embodiment.

The PC terminal 30 illustrated in FIG. 4 has a browser 310 that is executed by, for example, the CPU 16 or the like. Using the browser 310, the user of the PC terminal 30 can register in the service providing system 10 an application for using various services such as the “device information transmission service”.

The device 20 illustrated in FIG. 4 has a browser 210 that is executed by, for example, the CPU 31 or the like. Using the browser 210, the user of the device 20 can use various services such as the “device information transmission service”. In other words, the device 20 does not have to include a dedicated application program or the like for using various services provided by the service providing system 10, provided that the device 20 includes the browser 210.

The service providing system 10 illustrated in FIG. 4 includes an input/output service processing unit 110, a Web service processing unit 120, a document service unit 130, and a portal service unit 140. Each of these functional units is implemented by a process that one or more programs installed in the service providing system 10 cause the CPU 16 to execute.

In addition, the service providing system 10 includes an application information storage unit 150, an application screen information storage unit 160, and a portal screen information storage unit 170. Each of these storage units can be implemented by the HDD 18. In another example, at least one of the storage units can be implemented by a storage device or the like connected to the service providing system 10 via a network.

The input/output service processing unit 110 performs a process related to the service provided by the service providing system 10. The input/output service processing unit 110 includes an application managing unit 111 and a logic processing unit 112.

The application managing unit 111 manages application information 1000 stored in the application information storage unit 150. The application information 1000 is an application in which an order of execution of programs is defined so as to execute a process flow for providing a service. In other words, various services provided by the service providing system 10 are provided by the application information 1000.

In addition, in response to a request from the logic processing unit 112, the application managing unit 111 sends process flow information 1100 included in the application information 1000. The processing flow information 1100 is information in which a series of processes for implementing the service provided by the application information 1000 is defined.

Furthermore, in response to a request from the portal service unit 140, the application managing unit 111 stores the application information 1000 in the application information storage unit 150. With this, the application information 1000 (application) that provides the service is registered in the service providing system 10.

In response to a request from the Web service processing unit 120, the logic processing unit 112 acquires from the application managing unit 111 the process flow information 1100 included in the application information 1000. Then, on the basis of the process flow information 1100 acquired from the application managing unit 111, the logic processing unit 112 executes a series of processes (process flow) for implementing the service provided by the application information 1000. With this, the service providing system according to the present embodiment can provide various services such as the “device information transmission service”. Details of the logic processing unit 112 will be described later.

The Web service processing unit 120 performs a process for allowing the user to use various services by using the browser 210 of the device 20. In other words, the Web service processing unit 120 functions as an application server that provides a Web application (the application information 1000) to a browser 210. The Web service processing unit 120 includes a screen configuring unit 121 and an application executing unit 122.

In response to a request from the browser 210, the screen configuring unit 121 sends application screen information 2000 stored in the application screen information storage unit 160 and application settings information 1200 included in the application information 1000 stored in the application information storage unit 150.

The application screen information 2000 is information in which a model of a screen (application screen) for using a service provided by the application information 1000 is defined. The application screen information 2000 is information in which a model of an application screen is defined by, for example, HyperText Markup Language (HTML), Extensible HyperText Markup Language (XHTML), Cascading Style Sheets (CSS), JavaScript (registered trademark), or the like.

In addition, the application settings information 1200 is information in which various settings of an application (the application information 1000) are defined. For example, in the application settings information 1200, among parameter information used for executing a series of processes, parameter information input by the user, parameter information set by default, and the like are defined. In addition, for example, in the application settings information 1200, input items for the user to input parameter information on the application screen, display information (for example, an application name) on the application screen, and the like are defined. The application settings information 1200 is information in which various settings of the application are defined by, for example, JavaScript Object Notation (JSON) or the like.

With this, on the device 20, an application screen for using the service provided by the service providing system 10 is displayed by the browser 210.

In response to a request from the browser 210, the application executing unit 122 transmits a request for execution of the application (the application information 1000) to the input/output service processing unit 110.

The document service unit 130 executes a predetermined process included in a series of processes (process flow) based on the process flow information 1100. The document service unit 130 includes an OCR processing unit 131 and an e-mail delivering unit 132.

The OCR processing unit 131 performs an OCR process on an electronic file. The e-mail delivering unit 132 creates an e-mail to which the electronic file is attached, and transmits the e-mail to a specified e-mail address.

In addition to these, the document service unit 130 can also include various functions such as a compression/decompression processing unit for compressing or decompressing the electronic file, a data format conversion unit for converting a data format of the electronic file, for example.

The portal service unit 140 performs a process for allowing the user to perform application registration and the like by using the browser 310 of the PC terminal 30. The portal service unit 140 includes a user interface (UI) providing unit 141 and an application registering unit 142.

In response to a request from the browser 310, the UI providing unit 141 sends portal screen information 3000 stored in the portal screen information storage unit 170. The portal is a web site where application registration and the like can be performed by using the browser 310.

The portal screen information 3000 is information in which various screens such as a top screen of the portal (portal top screen) and an application registration screen are defined. The portal screen information 3000 is information in which various screens are defined in the browser 210 such as, for example, HTML, XML, CSS, and JavaScript.

With this, the portal top screen and the application registration screen are displayed on the PC terminal 30 by the browser 310. Therefore, the user of the PC terminal 30 can input, on the application registration screen, setting information for generating and registering an application (the application information 1000).

In response to a request from the UI providing unit 141, the application registering unit 142 requests the application managing unit 111 to register the application (the application information 1000). In other words, when an application registration operation is performed on the application registration screen, the application registering unit 142 requests the application managing unit 111 to register the application.

The application information storage unit 150 stores the application information 1000. The application information 1000 is associated with an application ID identifying the application information 1000 and stored in the application information storage unit 150. The application ID is, for example, a Uniform Resource Locator (URL) of the application information 1000, identification information included in the URL of the application information 1000, or the like.

The application information 1000 includes the process flow information 1100 and application settings information 1200. For example, the application information 1000 that provides the device information transmission service includes the process flow information 1100 in which a series of processes for providing the service is defined and the application settings information 1200 in which various settings of the application information 1000 are defined. Hereinafter, the application information 1000 that provides the device information transmission service is also referred to as a “device information transmission application”.

The application information 1000 can include two or more pieces of the process flow information 1100 and two or more pieces of the application settings information 1200.

As described above, the process flow information 1100 is information in which a series of processes (process flow) for providing the service provided by the application information 1000 is defined.

In addition, as described above, the application settings information 1200 is information in which various settings of an application (the application information 1000) are defined.

The application screen information storage unit 160 stores the application screen information 2000. The application screen information 2000 is stored in the application screen information storage unit 160 in association with the application ID.

The portal screen information storage unit 170 stores the portal screen information 3000. The portal screen information 3000 is stored in the portal screen information storage unit 170 in association with the URL of the portal top screen, the application registration screen, or the like and.

The input/output service processing unit 110, the web service processing unit 120, the document service unit 130, the portal service unit 140, and the like can be implemented by different information processing apparatuses.

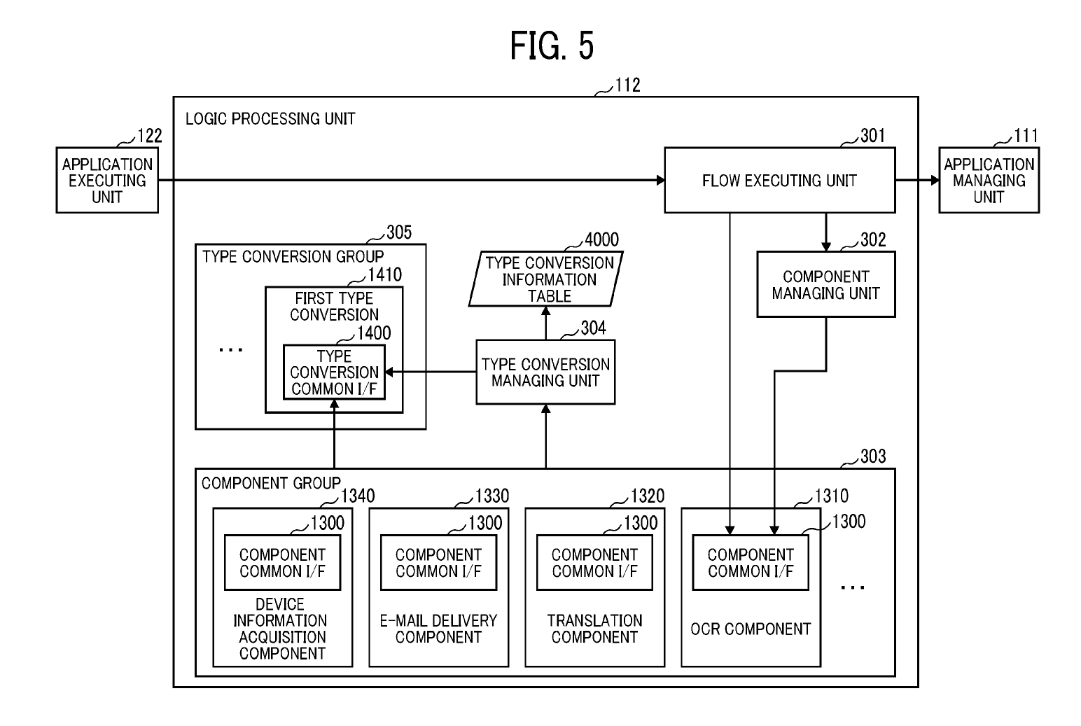

A detailed functional configuration of the logic processing unit 112 will be described with reference to FIG. 5. FIG. 5 is a block diagram illustrating an example of a functional configuration of the logic processing unit 112 according to the present embodiment.

The logic processing unit 112 illustrated in FIG. 5 includes a flow executing unit 301, a component managing unit 302, a component group 303, a type conversion managing unit 304, and a type conversion group 305. In addition, the logic processing unit 112 includes a type conversion information table 4000.

In response to receiving a request for execution of application from the application executing unit 122, the flow executing unit 301 acquires from the application managing unit 111 the process flow information 1100 corresponding to the execution request. Then, the flow executing unit 301 executes a series of processes (processing flow) based on the process flow information 1100 acquired from the application managing unit 111.

The series of processes based on the process flow information 1100 is executed by combining a component for executing each process included in the series of processes. The component is implemented by a program, a module, or the like for executing a process for implementing a predetermined function, and is defined by, for example, a class, a function, or the like.

The component managing unit 302 manages the component. In response to a request from the flow executing unit 301, the component managing unit 302 generates the component and transmits the generated component to the flow executing unit 301. The generation of a component means to develop a component defined by a class, a function, or the like on a memory (for example, the RAM 14).

The component group 303 is a set of components. The component group 303 includes an OCR component 1310, a translation component 1320, an e-mail delivery component 1330, and a device information acquisition component 1340.

The OCR component 1310 is a component for performing OCR processing on an electronic file (image file). The OCR component 1310 requests the OCR processing unit 131 of the document service unit 130 to perform an OCR process, thereby performing OCR processing on the electronic file.

The translation component 1320 is a component for translating a document of an electronic file such as a text file described in a predetermined language into another language.

The e-mail delivery component 1330 is a component for delivering an e-mail to a specified e-mail address. The e-mail delivery component 1330 also requests the e-mail delivering unit 132 of the document service unit 130 to perform an e-mail delivery process, thereby transmitting the e-mail to the specified e-mail address.

The device information acquisition component 1340 is a component for acquiring various information regarding the device 20 from the device 20.

In this manner, each component executes a process for implementing a predetermined function. In addition to the above components, the component group 303 includes various components such as an encryption/decryption component for encrypting and decrypting an electronic file, a compression component for compressing the electronic file, and the like.

In addition, each component included in the component group 303 includes a component common I/F 1300. The component common I/F 1300 is an Application Programming Interface (API) commonly defined for the components. The component common I/F includes an API for generating a component and an API for executing a process of the component.

In this manner, since each component has the component common I/F 1300, it is possible to localize influence due to the addition of components and the like. In other words, for example, it is possible to add a component or the like without affecting the flow executing unit 301, the component managing unit 302, and the like. With this, in the service providing system 10 according to the present embodiment, it is possible to reduce development man-hours required for addition of a predetermined function or the like (that is, addition of a component for executing a process for implementing the function, etc.).

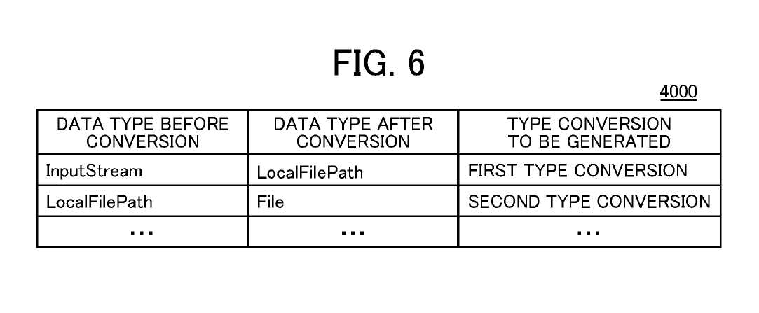

The type conversion managing unit 304 manages type conversion of data types. Each component has a predetermined data type that the component per se can handle. Therefore, in response to a request from the component, the type conversion managing unit 304 generates a type conversion included in the type conversion group 305, by referring to, for example, the type conversion information table 4000 illustrated in FIG. 6.

Then, the type conversion managing unit 304 requests the generated type conversion to execute a type conversion process. The type conversion is implemented by a program, a module, or the like that executes a type conversion process of a data type, and is defined by, for example, a class, a function, or the like. In addition, generation of the type conversion is to develop a type conversion defined by, for example, a class, function, or the like, on a memory (for example, the RAM 14).

The data type includes, for example, a data type “InputStream” indicating stream data, a “LocalFilePath” indicating a path (address) of an electronic file stored in a storage device or the like, and a “File” indicating an entity of the electronic file, and the like.

The type conversion information table 4000 will be described with reference to FIG. 6. FIG. 6 is a diagram illustrating an example of the type conversion information table 4000.

The type conversion information table 4000 illustrated in FIG. 6 includes, as data items, a data type before conversion, a data type after conversion, and a type conversion to be generated. In other words, type conversion information stored in the type conversion information table 4000 is information in which, for each data type before conversion and for each data type after conversion, a type conversion for converting the data type before the conversion to the data type after the conversion is associated.

The type conversion group 305 is a set of type conversions. The type conversion group 305 includes a first type conversion 1410 for converting the data type “InputStream” to “LocalFilePath”. The type conversion group 305 also includes, for example, a second type conversion or the like for converting the data type “LocalFilePath” to “File”.

In addition, each type conversion included in the type conversion group 305 includes a type conversion common I/F 1400. The type conversion common I/F 1400 is an API commonly defined for the type conversions. The type conversion common I/F 1400 includes an API for generating a type conversion and an API for executing a type conversion process of a type conversion.

In this manner, each type conversion includes the type conversion common I/F 1400, and thus it is possible to localize influence due to addition of a type conversion and the like. In other words, for example, it is possible to add a type conversion or the like without affecting the type conversion managing unit 304 or the like. With this, in the service providing system 10 according to the present embodiment, it is possible to reduce development man-hours required for addition of a type conversion and the like.

### Details of Processes

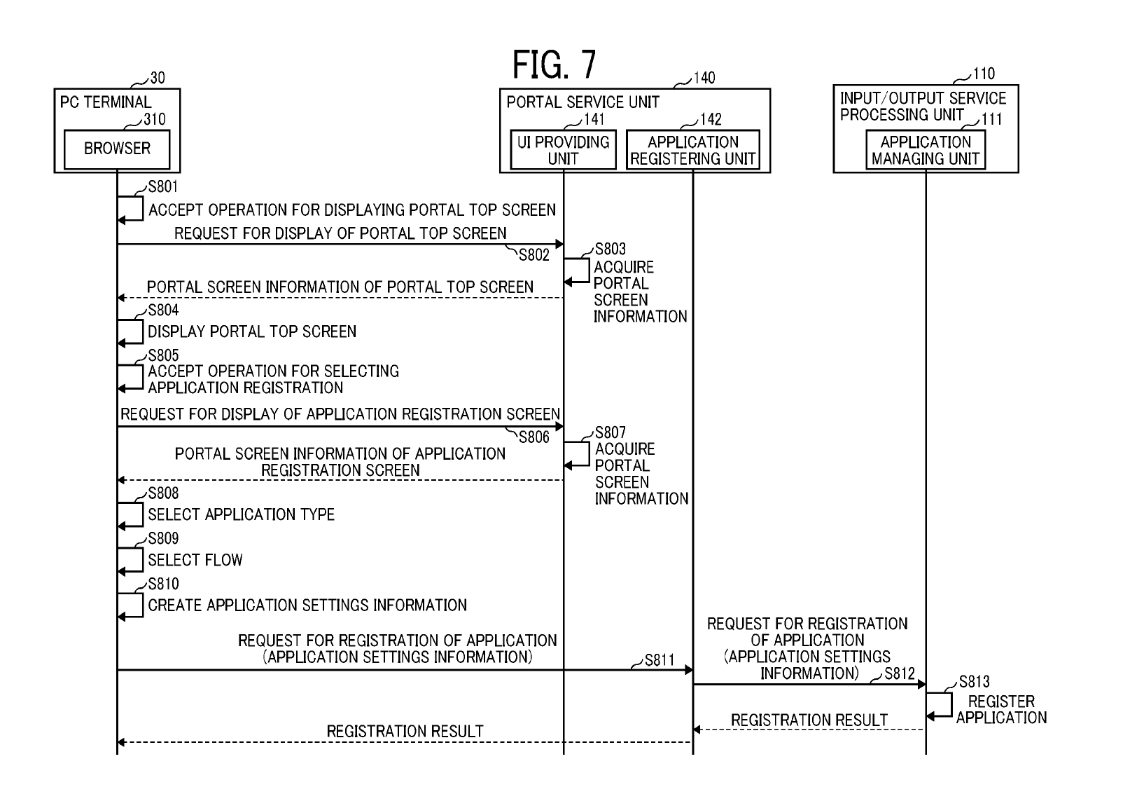

Next, details of processes of the information processing system 1 according to the present embodiment will be described. First, a description is given of a process of registering an application implementing a desired process flow in the service providing system 10 according to an operation by a user to the PC terminal 30, with reference to FIG. 7. FIG. 7 is a sequence diagram illustrating an example of an application registration process.

First, the browser 310 of the PC terminal 30 receives an operation for displaying the portal top screen (a display operation of the portal top screen) (step S 801). The user of the PC terminal 30 can perform the display operation of the portal top screen by inputting an URL of the portal top screen in an address bar of the browser 310, for example.

In response to receiving the operation for displaying the portal top screen, the browser 310 of the PC terminal 30 transmits a request for displaying the portal top screen to the UI providing unit 141 of the portal service unit 40 (step S802).

In response to receiving a request for acquisition of the portal top screen, the UI providing unit 141 of the portal service unit 140 acquires the portal screen information of the portal top screen from the portal screen information storage unit 170 (step S803). Then, the UI providing unit 141 sends to the browser 310 the portal screen information acquired from the portal screen information storage unit 170.

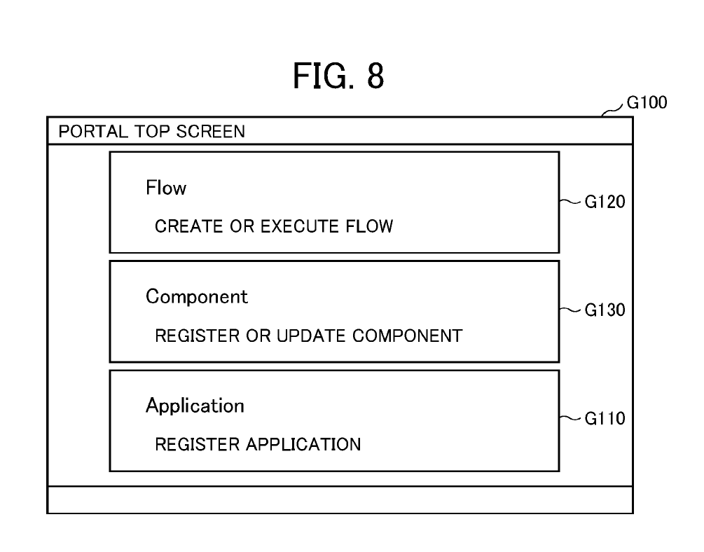

In response to receiving the portal screen information of the portal top screen, the browser 310 of the PC terminal 30 displays a portal top screen G100 illustrated in, for example, FIG. 8, on the basis of the portal screen information (step S804).

The portal top screen G100 illustrated in FIG. 8 is a top screen of the portal and includes an “Application” button G110 for registering an application. Hereinafter, it is assumed that the user performs an operation for selecting the “Application” button G110 on the portal top screen G100 (selection operation of application registration) illustrated in FIG. 8.

The portal top screen G100 illustrated in FIG. 8 also includes a “Flow” button G120 for creating the process flow information 1100, a “Component” button G130 for registering a component. In this manner, in the portal top screen G100, in addition to registering applications, it is possible to create and execute a process flow, register and update a component, and the like.

The browser 310 of the PC terminal 30 receives an operation for selecting application registration performed by the user (step S805).

In response to receiving the operation for selecting application registration, the browser 310 of the PC terminal 30 transmits a request for display of the application registration screen to the UI providing unit 141 of the portal service unit 40 (step S806).

In response receiving the request for display of the application registration screen, the UI providing unit 141 of the portal service unit 140 acquires from the portal screen information storage unit 170 the portal screen information of the application registration screen (step S807). Then, the UI providing unit 141 transmits to the browser 310 the portal screen information acquired from the portal screen information storage unit 170.

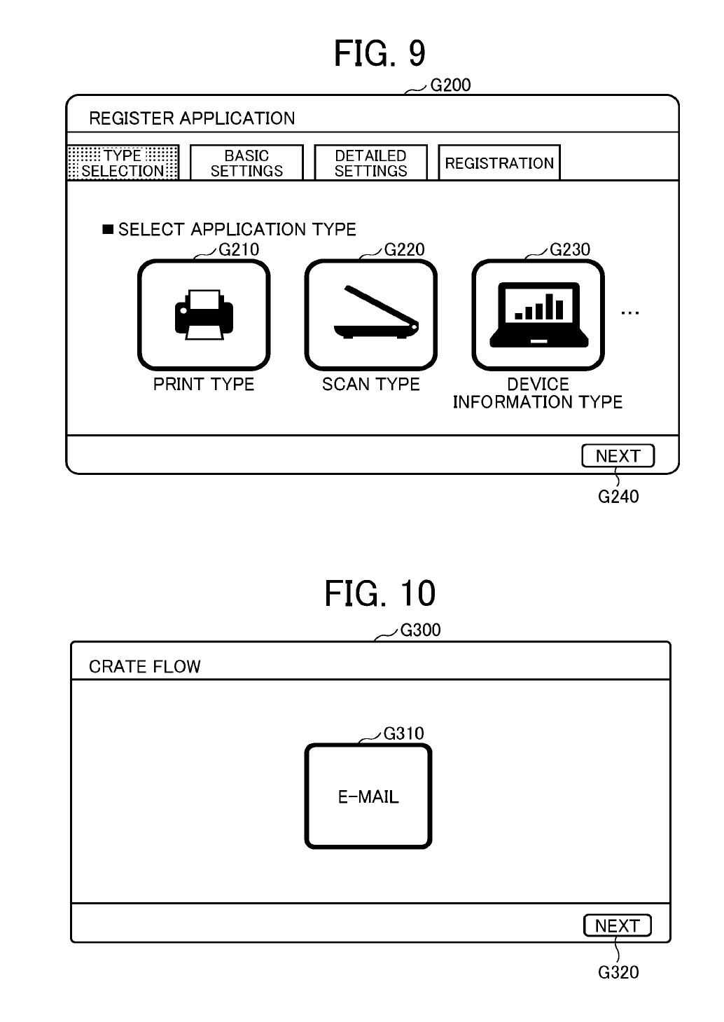

In response to receiving the portal screen information of the application registration screen, the browser 310 of the PC terminal 30 displays an application registration screen G200 illustrated in, for example, FIG. 9, on the basis of the portal screen information (step S808). An application registration screen G200 illustrated in FIG. 9 is a screen for allowing the user to select a type of an application to be registered.

The application registration screen G200 illustrated in FIG. 9 includes a “PRINT TYPE” button G210 for registering a print type application, a “SCAN TYPE” button G220 for registering a scan type application, and a “DEVICE INFORMATION TYPE” button G230 for registering a device information type application. The application registration screen G200 illustrated in FIG. 9 can include, for example, a “FAX TYPE” button for registering a fax type application, an “E-MAIL RECEIVING TYPE” button for registering an e-mail receiving type application, and the like. In addition, the application registration screen G200 illustrated in FIG. 9 includes a “NEXT” button G240 for a transition to a next screen.

The print type is an application of a type that causes an image forming apparatus or the like to print an electronic file indicating an execution result by a series of processes. The scan type is an application of a type that executes a series of processes by using an electronic file generated by scanning in the image forming apparatus or the like as an input. The device information type is an application of a type that acquires information regarding the device 20 and executes a series of processes by using the acquired information as an input. The FAX type is an application of a type that causes the image forming apparatus or the like to facsimile an electronic file indicating the execution result by a series of processes. The e-mail receiving type is an application of a type that executes a series of processes by using an electronic file attached to an e-mail received by the image forming apparatus or the like as an input.

Hereinafter, registration of an application according to the device information transmission service will be described. In the application registration screen G200 illustrated in FIG. 9, it is assumed that the user has performed an operation in which the user has selected the “DEVICE INFORMATION TYPE” button G230 and pressed the “NEXT” button G240. Then, the browser 310 receives the operation and displays a predetermined application registration screen. The application registration screen is a screen for allowing the user to set basic information of the application.

In response to completion of a selection of an application type, the browser 310 starts to select a flow (step S809). A flow registration screen G300 illustrated in FIG. 10 is a screen for allowing the user to create a flow or to select a certain flow from already created flows.

The flow registration screen G300 illustrated in FIG. 10 is a screen for setting how to process the acquired device information. The flow registration screen G300 illustrated in FIG. 10 includes an “E-MAIL” button G310 indicating a process for transmitting an e-mail including the acquired device information to a predetermined transmission destination, a “NEXT” button G320 for a transition to a next screen. The flow registration screen G300 can include buttons indicating processes other than the e-mail transmission.

In response to completion of a selection of a flow, the browser 310 creates the application settings information 1200 (step S810). The application settings information 1200 is information in which the application type and flow selected as described above and other appropriate information are associated, and is information that needs to be set when executing the application.

In response to creating the application settings information 1200, the browser 310 transmits a request for registration of an application to the application registering unit 142 of the portal service unit 140 (step S811). The request for registration of the application includes the application settings information 1200 created in step S810.

In response to receiving the request for registration of the application, the application registering unit 142 of the portal service unit 140 transmits the registration request to the application managing unit 111 of the input/output service processing unit 110 (step S812).

In response to receiving the request for registration of the application, the application managing unit 111 of the input/output service processing unit 110 registers the application (step S813). Then, the application managing unit 111 transmits a registration result to the browser 310.

More specifically, the application managing unit 111 associates, the application settings information 1200 included in the request for registration of the application, with the application ID and stores the application settings information 1200 in the application information storage unit 150. With this, the application information 1000 including the application settings information 1200 and the process flow information 1100 having a flow name defined by a flow name 1205 in the application settings information 1200 is registered in the service providing system 10.

Thus, in the information processing system 1 according to the present embodiment, the user can register the application in the service providing system 10 by using the PC terminal 30. Moreover, in the information processing system 1 according to the present embodiment, the user can easily register the application (the application information 1000) by, for example, setting the flow name, the parameter information of each component, and the like by using the PC terminal 30.

Therefore, on the basis of the information processing system 1 according to the present embodiment, even a user (for example, a planner, etc.) who does not have expert knowledge or experience such as, for example, a programming language or the like, can register an application (the application information 1000).

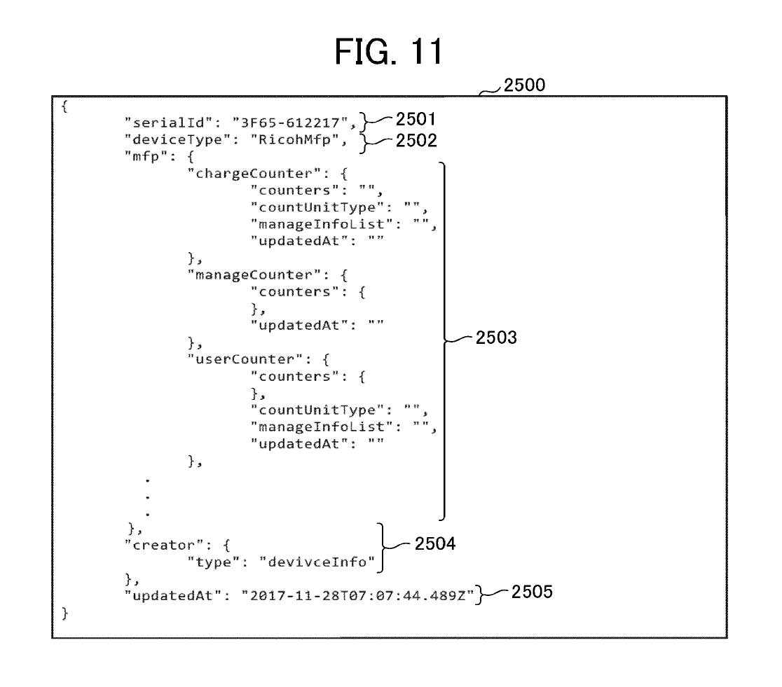

FIG. 11 is a diagram illustrating an example of device information 2500 according to the embodiment. The device information 2500 illustrated in FIG. 11 is text format data, and includes serial information 2501 uniquely assigned to each device information 2500, device information 2502 specifying the device 20, parameter information 2503 regarding the device 20 (in this example, a counter value of the MFP), manufacturer information 2504 indicating a manufacturer of the device 20, and update information 2505 indicating update date and time of firmware or the like of the device 20. A data structure of the device information 2500 is not limited to the one illustrated in FIG. 11. For example, the parameter information 2503 can include a toner remaining amount, failure information, and the like.

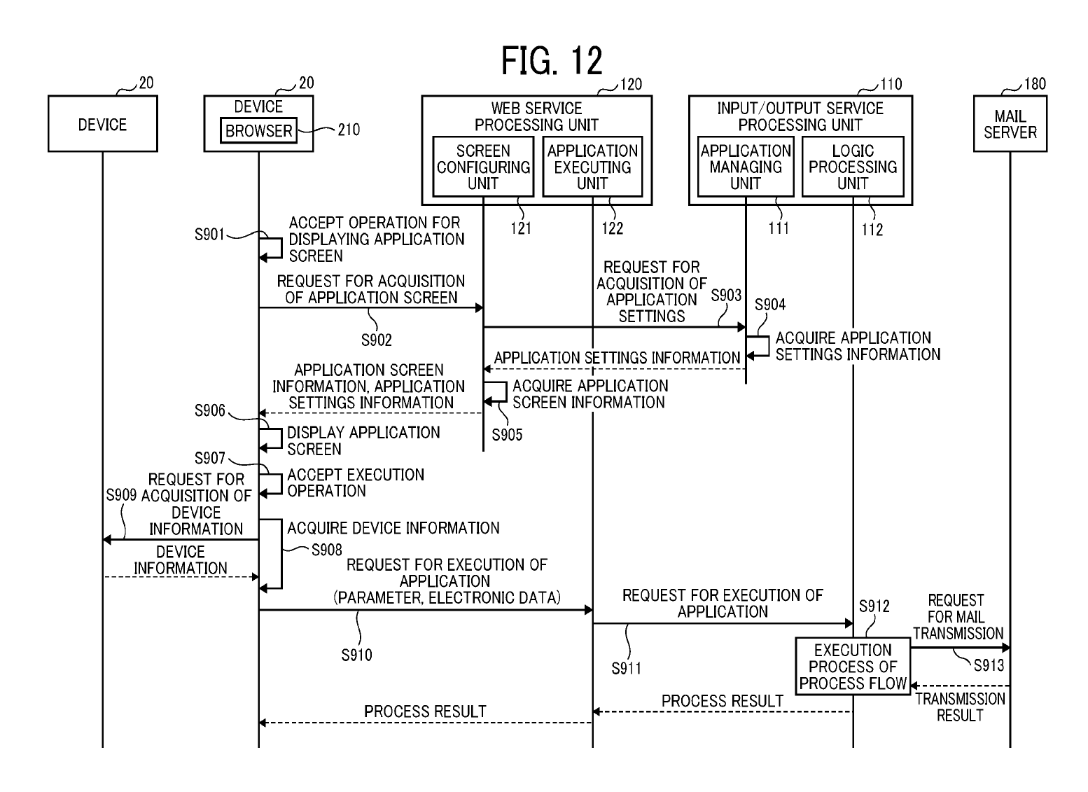

FIG. 12 is a sequence diagram illustrating an example of an overall process in a case where the device information transmission service according to the embodiment is used. First, the browser 210 of the device 20 accepts an operation (display operation) for displaying the application screen of the device information transmission service (step S901).

In response to receiving the operation for displaying the application screen of the device information transmission service, the browser 210 transmits, a request for displaying the application screen of the device information transmission service, to the screen configuring unit 121 of the Web service processing unit 120 (step S902). The request for displaying the application screen of the device information transmission service includes the application ID of the application information 1000 that provides the device information transmission service.

In response to receiving the request for displaying the application screen of the device information transmission service, the screen configuring unit 121 of the Web service processing unit 120 transmits a request for acquisition of the application settings to the application managing unit 111 of the input/output service processing unit 110 (step S903). The request for acquisition of the application settings includes the application ID of the application information 1000 that provides the device information transmission service.

In response to receiving the request for acquisition of the application settings, the application managing unit 111 of the input/output service processing unit 110 acquires from the application information storage unit 150 the application settings information 1200 stored in association with the application ID included in the acquisition request (step S904). Then, the application managing unit 111 transmits to the screen configuring unit 121 the application settings information 1200 acquired from the application information storage unit 150.

Next, the screen configuring unit 121 of the Web service processing unit 120 acquires from the application screen information storage unit 160 the application screen information 2000 stored in association with the application ID of the application information 1000 that provides the device information transmission service (step S905). Then, the screen configuring unit 121 transmits to the browser 210 the application screen information 2000 acquired from the application screen information storage unit 160 and the application settings information 1200 transmitted in the above step S904.

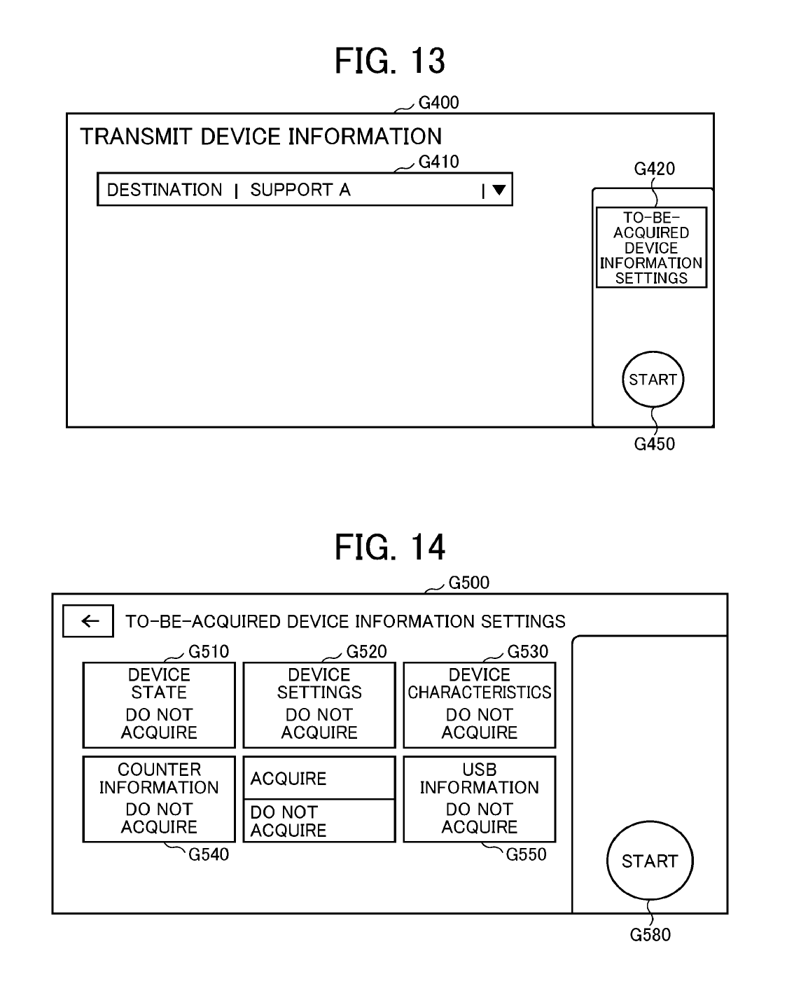

On the basis of the application screen information 2000 and the application settings information 1200 received from the screen configuring unit 121, the browser 210 displays the first application screen G400 illustrated in FIG. 13 and the second application screen G500 illustrated in FIG. 14, for example (step S906). The first application screen G400 and the second application screen G500 are screens for allowing the user of the device 20 to use the device information transmission service.

The first application screen G400 illustrated in FIG. 13 includes a transmission destination input area G410, a to-be-acquired device information settings button G420, and a “START” button G450. The transmission destination input area G410 is a user interface for setting the information processing apparatus to which the acquired device information 2500 is to be transmitted. The transmission destination input area is displayed on the basis of the application settings information 1200. The to-be-acquired device information settings button G420 is a user interface for displaying the second application screen G500 illustrated in FIG. 14. The “START” button G450 is a user interface for starting the device information transmission service on the basis of the set content.

When the to-be-acquired device information settings button G420 of the first application screen G400 is pressed, a second application screen G500 illustrated in FIG. 14 is displayed. In the second application screen G500, an area for selecting a type of information to be acquired is included. In this example, a “device information” setting area G510 for setting whether information indicating a state of the device 20 is to be acquired, an “device settings” setting area G520 for setting whether information indicating settings of the device 20 is to be acquired, an “device characteristics” setting area G530 for setting whether information indicating characteristics of the device 20 is to be acquired, a “counter information” setting area G540 for setting whether counter information held by the device 20 is to be acquired, and a “USB information” setting area G550 for setting whether information regarding a USB is to be acquired are included. In addition, the second application screen G500 includes a “START” button G580 for starting the device information transmission service on the basis of the set content.

In this manner, on the application screen for allowing the user of the device 20 to use the service, on the basis of the information defined in the application settings information 1200, the transmission destination of the device information 2500 and the type of information included in the device information 2500 are displayed.

When an operation (execution operation) of pressing the “START” button G450 of the first application screen G400 or the “START” button G580 of the second application screen G500 is performed, the browser 210 receives an execution operation (step S907).

In response to receiving the execution operation, the browser 210 starts a process for acquiring the device information 2500 (step S908), and transmits a request for acquisition of device information to the device 20 (step S909). The request for acquisition of the device information according to the present example includes information indicating the set content in the second application screen G500. The device 20 transmits the device information 2500 to the browser 210 of the device 20 as a response to the request for acquisition of the device information.

In response to acquiring the device information 2500, the browser 210 transmits a request for execution of an application to the application executing unit 122 of the Web service processing unit 120 (step S910). The request for execution of the application includes a parameter (for example, an e-mail address of a transmission destination) and electronic data (text format data including the acquired device information).

In response to receiving the request for execution of the application, the application executing unit 122 of the Web service processing unit 120 transmits the execution request to the logic processing unit 112 of the input/output service processing unit 110 (step S911).

In response to receiving the request for execution of the application, the logic processing unit 112 performs an execution process of a process flow (step S912). Specifically, the logic processing unit 112 executes a process flow constituted as a series of processes for providing the device information transmission service. In the present embodiment, the logic processing unit 112 transmits to an e-mail server 180 a request for e-mail transmission for transmitting an e-mail including the acquired device information 2500 to a transmission destination (support A in this example) set on the first application screen G400 (step S913). The e-mail server 180 transmits a transmission result to the logic processing unit 112 as a response to the request for the e-mail transmission. The logic processing unit 112 transmits a process result based on the received transmission result to the application executing unit 122 as a response to the request for execution of the application. The application executing unit 122 transmits the received process result to the browser 210 of the device 20 as a response to the request for execution of the application.

As described above, the information processing system 1 according to the present embodiment can input the device information 2500 acquired from the device 20 as an input to a predetermined process flow. As described in the present embodiment, it is possible to provide a device information transmission service for transmitting e-mail to a transmission destination as an example. For example, it is possible to provide a service for transmitting to an information processing apparatus used by an administrator, a maintenance agent or the like of the device 20 the device information 2500 related to a use frequency, failure, expendables, firmware, settings, and the like of the device 20. An e-mail transmission is just an example, and the device information 2500 can be transmitted in any suitable manner other than the e-mail, which is selected according to a usage condition. For example, the device information 2500 can be automatically accumulated in a predetermined folder provided in a storage.

In addition, while, as an example, the process flow for transmitting the acquired device information 2500 to the administrator or the like by e-mail has been described, the present disclosure is not limited to this. The acquired device information 2500 can be transmitted to various systems that use the device information 2500. Examples of the system include a device management system that remotely monitors a state, an operation status, and an operation log of device, an order management system that automatically orders an expendable such as a toner and an inventory management system, and various other business systems.

In addition, on the basis of the information processing system 1 according to the present embodiment, the user can register, the application information 1000 that provides various services, in the service providing system 10 by using the device 20. In addition, the user can easily register the application information 1000 by selecting the flow name by using the PC terminal 30 and then setting needed parameter information and the like.

Therefore, on the basis of the information processing system 1 according to the present embodiment, even a user who does not have expert knowledge or experience such as, for example, a programming language or the like can create and use an application (the application information 1000). In addition, the user can receive various kinds of services by using the application registered in the service providing system 10 via the operation panel 22 of the device 20.

According to an embodiment of the present disclosure, in a system that executes a process flow using functions of a device, it is possible to easily provide a service that acquires and uses device information regarding the device.

A program for achieving the function of the information processing system 1 is stored in a computer-readable storage medium such as a CD-ROM, a memory card, a CD-R and a Digital Versatile Disk (DVD) in a file in an installable format or an executable format, and provided as a computer program product.

In addition, the program may be stored on a computer connected to a network such as the Internet and may be provided by being downloaded via the network. Alternatively, the program may be provided via a network such as the Internet without being downloaded. Alternatively, the program may be provided by being incorporated in a ROM or the like in advance. In addition, the program may have a module configuration including a function implementable by the program among the functional units included in the information processing system 1. The function implemented by the program is loaded into a main storage device by reading the program from a storage medium and executing the program. In other words, the function implemented by the program is generated on the main storage device.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information processing system comprising:
a device having one or more functions; and
a service providing system configured to execute an application in which an execution order of programs is defined to execute a process flow using at least one of the one or more functions, wherein
the service providing system comprising circuitry configured to:
acquire device information regarding the device from the device based on setting information input by a user via an operation device provided with the device; and
execute the process flow for processing the acquired device information.

2. The information processing system according to claim 1, wherein
the process flow executed by the circuitry is to transmit the acquired device information to a predetermined transmission destination.

3. The information processing system according to claim 2, wherein
the circuitry is further configured to provide a user interface for allowing a user to set the transmission destination via the operation device of the device.

4. The information processing system according to claim 2, wherein
the circuitry is further configured to provide a user interface for allowing a user to set content of the device information to be acquired from the device via the operation device of the device.

5. The information processing system according to claim 1, wherein
the device information is transmitted to a predetermined destination by e-mail.

6. The information processing system according to claim 1, wherein
the device information is text format data.

7. An information processing method for executing an application in which an execution order of programs is defined to execute a process flow using one or more functions of a device, the method comprising:
acquiring device information regarding the device from the device based on setting information input by a user; and
executing the process flow for processing the acquired device information.

8. Anon-transitory computer-readable storage medium storing a program for causing, a computer configured to execute an application in which an execution order of programs is defined to execute a process flow using one or more functions of a device, to execute:
a process of acquiring device information regarding the device from the device based on setting information input by a user; and
a process of executing the process flow for processing the acquired device information.
